(19) United States
(12) Patent Application Publication
(10) Pub. No.: US 2015/0142446 A1
(43) Pub. Date: May 21, 2015

(54) Credit Risk Decision Management System And Method Using Voice Analytics

(71) Applicant: Global Analytics, Inc., San Diego, CA (US)

(72) Inventors: Krishna Raj Gopinathan, San Diego, CA (US); Jagat Chaitanya, Chennai (IN); Sudalai Raj Kumar, Chennai (IN); Sriram Rangarajan, Chennai (IN)

(21) Appl. No.: 14/549,505

(22) Filed: Nov. 20, 2014

Related U.S. Application Data
(60) Provisional application No. 61/907,309, filed on Nov. 21, 2013.

(51) Int. Cl. G06Q 40/02; G10L 25/48

(52) U.S. Cl. CPC G06Q 40/025; G10L 25/48
USPC 704/270; 705/38

(57) ABSTRACT

A credit risk decision management system and method using voice analytics are disclosed. The voice analysis may be applied to speaker authentication and emotion detection. The system introduces use of voice analysis as a tool for credit assessment, fraud detection and a measure of customer satisfaction and return rate probability when lending to an individual or a group. Emotions in voice interactions during a credit granting process are shown to have high correlation with specific loan outcomes. This system may predicts lending outcomes that determine if a customer might face financial difficulty in near future and ascertains affordable credit limit for such a customer. Information carrying features are extracted from the customer's voice files, and mathematical and logical transformations are performed on these features to get derived features. The data is then fed to a predictive model which captures the probability of default, intent to pay and fraudulent activity involved in a credit transaction. The voice prints can also be transcribed into text and text analytics can be performed on the data obtained to infer similar lending outcomes using Natural Language Processing and predictive modeling techniques.

### PRIORITY CLAIM/RELATED APPLICATIONS

This application claims the benefit under 35 USC 119(e) and priority under 35 USC 120 to U.S. Provisional Patent Application Ser. No. 61/907,309 filed on Nov. 21, 2014 and entitled “Credit Risk Decision Management System and Method Using Voice Analytics”, the entirety of which is incorporated herein by reference.

### FIELD

The embodiments described herein relate to field of credit risk management using voice analytics. More particularly, it implements voice analysis as a tool for predicting credit risk, determine creditworthiness and fraud associated to a transaction involving a consumer, organization, family, business or a group of consumers as one entity. The embodiments described also pertain to emotion detection and predictive analytics as applied to measurement of customer satisfaction and return rate probability.

### BACKGROUND

Many methods have been implemented to manage credit risk and mitigate fraud and credit history and identity data is each essential to prudent and efficient credit management. Traditionally, data used for building predictive models for credit risk consists of performance and behavior of previous credit transactions, credit obligations of the prospective borrowers, income and employment. These types of data represent behavior/characteristics of individuals captured externally.

### BRIEF DESCRIPTION OF THE DRAWINGS

A further understanding of the nature and advantages of the present embodiments may be realized by reference to the remaining portions of the specification and the drawings wherein reference numerals are used throughout the drawings to refer to similar components.

FIG. 1 is a general flow diagram illustrating the processes and components of the present system as used for fraud detection and credit assessment;

FIG. 2 is a general flow diagram illustrating the processes and components of the present system as used for measuring customer satisfaction and return rate probability;

FIG. 3 is a general flow diagram illustrating the major functions and operations of the present system;

FIG. 4 is an algorithm flowchart diagram illustrating the processes and components of the data pre-processing part (for removing the automated frames from the voice files) of present system;

FIG. 5 is an algorithm flowchart diagram illustrating the processes and components of the data pre-processing part (for isolating the customer voices from the voice files) of present system;

FIG. 6 is an algorithm flowchart diagram illustrating the processes and components of the model building part of present system;

FIG. 7 is an algorithm flowchart diagram illustrating the processes and components of voice to text conversion and text analysis module.

### DETAILED DESCRIPTION OF ONE OR MORE EMBODIMENTS

The disclosure is particularly directed to a credit risk decision system for loan applications (a lending environment) that uses voice analytics from customer/borrower conversations and it is in this context that the system and method is described below. However, the system and method described below also may be used other types of credit risk decisions, other financial decisions and the like.

There is a significant opportunity to improve the performance of credit decisions with the use of voice data (which includes but is not restricted to historical as well as real time recorded conversations between agents representing the business and potential/current customers) to build predictive models to determine credit risk and detect fraud. Voice analysis attempts to characterize traits of an individual using reactive data obtained from aforementioned conversations. For example, voice analysis techniques have been successful in areas such as speaker authentication and emotion detection.

Extracting predictive signals from human conversation in a lending environment has several high potential applications. For example, lending businesses often have access to large number of recorded conversations between their representative agents and their customers along with loan outcomes. Using these recordings for voice analysis, significant ability to predict risk and fraud can be achieved.

Building a strong predictive model, training and validating it, requires relevant data. When trying to manage credit risk and predict fraud using voice analytics, the data as provided by the lending business outcomes could be considered most relevant. In cases when a customer's credit history does not exist or if this information is scanty, additional data can be obtained using references from customers with available credit history. In addition to the normal application process, for all customers or in case of customers portraying higher risk and probability of default, these references can be captured in the form of conversations between representative agents and customers/potential customers/referrers. The voice features extracted from these recordings provide additional input to the predictive models. For example a linear regression model for predicting the risk associated with a lending transaction may be used. A typical regression model (M1) is built taking data obtained from lending transactions, identity data, credit history data and transformation of these variables as input. Let a customer (C) have a probability of 0.80 of defaulting on his repayments. The regression model M1 may predict the probability to be 0.68. Now let us build another regression model (M2) which takes variables created on voice recordings as input data in addition to all the input data of model M1. The described system extracts useful information from voice recordings which could be fed into this regression model. These variables are capable of predicting credit risk or fraudulent activity associated to a transaction because they quantify traits of human behavior that traditional data fails to do. The regression model M2 predicts a probability of 0.77 which is a better estimate of customer C defaulting on his repayments.

For example, when lending to a group, the customers are collectively responsible for repayments as a group. The behavioral traits of each member contribute to analyzing the group as a whole. Voice analysis as described in the embodiments could be used to assess behavioral characteristics, immoral and fraudulent activity in a group.

As another example, a customer, during an active loan term, might find it difficult to repay the entire or part of the repayments of his remaining loan. This customer may request the lender for an arrangement that would make it affordable for the customer to repay the loan. Voice analytics as applied to predictive modeling will help to identify customers who may in the near future opt for such arrangements and also predict fraudulent activity associated with such cases.

As another example, lenders rely on pre-authorized payments to collect the amount lent to borrowers. Such a setup allows a lender to withdraw money from the customer's bank account, directly or by using his/her debit or credit card, following a designated and agreed upon (between the lender and borrower) repayment schedule. The borrower however, has a right to cancel this authority anytime he/she wishes to. Voice analytics as described herein could be used to calculate such intent to cancel pre-authorized payments and evaluate fraud risk associated with such cases.

As described herein, some of the voice features generated from communication with the customers can also be transcribed into text, and Natural language Processing can be applied to the resulting textual data to be used as input for models predicting credit risk or fraud.

In accordance with an embodiment, an automated system and method for management of credit risk and detection of fraud which uses voice analytics may be provided that extracts predictive features from customers' voices and uses them as input for predictive models to determine risk of credit default or fraud. The resulting predictive models are applied either independently or in conjunction with other models built on traditional credit data to arrive at credit/fraud decisions.

Another embodiment of the system may use Gaussian mixture model and other clustering and classification techniques to isolate the customers' voices from the recorded conversations (also referred to as the dataset of conversations). The recorded conversations may be stored in any number of standard audio file formats (like .wav, .mp3, .flac, .ogg, etc). This method and system may use primary features and derived features that are extracted directly from the voice files, for the analysis. The primary features are classified based on the domain from which they are extracted. For example, time domain primary features capture the variation of amplitude with respect to time and frequency domain primary features capture the variation of amplitude and phase with respect to frequency. Derived features used in this method include, but are not limited to, derivatives of formant frequencies, first and second order derivatives of Mel Frequency Cepstral Coefficients, maximum and minimum deviation from mean value, mean deviation between the adjacent samples, and frequency distribution on aggregated deviations. Derived features also include digital filters computed on each of these entities, across multiple conversations involving the customers and/or the agents (involved in the current conversation).

Mel frequency cepstral coefficients (MFCC) are features often used in voice analysis. A cepstrum is the result of taking the Fourier transformation (FT) of the logarithm of the estimated spectrum of a signal. A Mel frequency cepstrum (MFC) is a representation of the short-term power spectrum of a sound, based on a linear cosine transform of a log power spectrum on a nonlinear Mel scale of frequency. Mel frequency cepstral coefficients (MFCCs) are coefficients that collectively make up an MFC. MFCCs are widely used because the frequency bands are spaced on the Mel scale in a manner that approximates the human auditory system's response more closely than the linearly-spaced frequency bands used in the normal cepstrum.

In an embodiment of the system, a complete conversation may be split into multiple segments for generating additional features for predictive modeling. The definition of the segments can vary depending on the business and available data. Each segment of a conversation can be any subset of (but not restricted to) the following:

a. Question(s) and answer(s) [as asked by agents to potential/current customers].

b. One or more instances of specific dialogue between the agent and the customer, representing predetermined topics

c. Different phases of the conversation (introduction/warming up, problem details, resolution of the issues, feedback etc)

The segmentation described above can be achieved by various means depending on the business, data and technology available. These include (but are not limited to): tagging of conversations by agents (in real time or after the fact) and using them to achieve the splits; split by identifying pauses in dialogue; searching for instances of specific keywords related to specific questions and using that to split; matching conversation timing with data/record entry timings (especially for questions whose answers generate data input) to identify split points, and so on. The segmentation applied need not be unique—i.e multiple segmentations can be applied on any given dataset of conversations and all of them can be used for generating features. An example of a simple segmentation may be: a split between the introductory phase of the conversation (where the customer/agent identify themselves) and the information phase (where the problem is described, discussed and potentially resolved). Another example of segmentation may be the conversation split by each individual question/answer pair. Different types of segmentations can be combined to create second order (and higher order) segmentations. For example, a conversation split by question/answer and phase (introduction, problem description, etc)

For each type of segmentation applied to the dataset of conversations, various features are computed from within the segments in much the same way as described before (including but not limited to: amplitude, variance of amplitude, derivatives of formant frequencies, first and second order derivatives of Mel Frequency Cepstral Coefficients, maximum and minimum deviation from mean value, mean deviation between the adjacent samples, frequency distribution on aggregated deviations, and digital filters computed on these features). Additional variables may be generated that compare the derived variables from these segments against each other. These variables can vary from simple functions like mathematical difference or ratios to more involved comparative functions that (usually) produce dimensionless output. These features may be included as input for predictive modeling. For example, in a conversation split into introductory and information segments, a simple feature derived this way can be the ratio of [variance of amplitude of customer's voice in the introductory segment] and [variance of amplitude of customer's voice in the information segment].

A special type of segmentation may also be applied by identifying words used frequently by the (potential) customer during the conversations and splitting the conversation by occurrence of these words. Second (and higher) order segmentations (including interactions with other segmentations) may also be computed here, to augment the feature extraction. The derived variables are computed as before by computing the primary and secondary features on each segment and applying comparative functions across segments to create the new variables. Similarly, additional variables are created by comparing current conversation (segmented or otherwise) with past conversations (segmented or otherwise) involving the same (potential) customer. The variables can also be comparative functions applied to digital filter variables computed across these conversations (both segmented and as a whole).

In another embodiment, the primary and derived features (from the conversation as a whole as well as all segmented variations computed) are fed into a system that makes use of predictive modeling. The various modeling techniques used by this embodiment include, but are not limited to, Regression, Neural networks, Support Vector Machines, Classification And Regression Trees, Residual modeling, Bayesian forest, Random forest, Deep learning, Ensemble modeling, and Boosted decision trees.

An embodiment of the present system enables detection of human emotions which may include nervousness, disinterest (maybe in paying back the dues), overconfidence (could be identifier of fraudsters) as pertaining to their present and future credit performance.

Another embodiment involves use of voice printing dependent methods for management of credit risk and detection of fraud. These include voice analysis for identity and emotion detection to analyze the applicant's intent to pay and fraudulent behavior.

In a yet another embodiment, this system may make use of voice printing independent methods for management of credit risk and fraud detection. These include use of voice analysis in predictive models to score the applicant's intent to pay and probability of a fraudulent attempt.

A further embodiment of the present system would find application in measurement and improvement of customer satisfaction and customer return rate probability. This may be achieved by categorizing the customers' voices in real time and providing recommendations on agents' responses that result in highest customer satisfaction and better return rates.

In another embodiment, the system evaluates an application making use of the reference information. The reference information constitutes of credit history and identity information on the reference along with real time or recorded conversations between an applicant's referrers and representative agents. Voice analysis in this embodiment also enables detection of emotion associated with the transaction. Emotion detection applied to a referrer's voice helps identify if what they are saying is the truth or are they lying or are they being coerced to give reference, etc.

According to one embodiment, the system may be used to evaluate the credit worthiness of a group of consumers as one entity. Each member of the group is evaluated and scored for credit risk and fraudulent activity separately and together as a group. Voice analytics feature driven predictive models as described herein counters potential fraudulent activity/collusion within and across groups. The reasons for a member leaving or joining a particular group, reasons for inviting a new member, reasons behind a particular member not paying or always paying, could be classified using voice analytics.

In another embodiment, voice analytics as applied to predictive modeling is used to identify the customers who might end up in financial distress during an active loan term and request for lenient or more affordable arrangements. Customers who have taken out a loan might find it difficult to repay it due to change in their cash flows. In such cases, the customer can request the lender for an arrangement where certain lenient terms are put into place for this special scenario to make the repayments affordable for the customer and reduce his/her unsecured debt. Voice analytics as applied to predictive modeling can potentially identify customers who are likely to opt for such arrangements in the future and these customers can therefore be treated with additional care so that they can afford to repay their loan. This embodiment can also predict the possibility of fraudulent activity associated with such cases. These arrangements that a customer may request for, vary with the customer's financial debt and include, but are not limited to Temporary arrangements, Debt Management Plans, and Individual Voluntary Arrangements.

In another embodiment, voice analytics may be used to identify borrowers who may attempt to cancel their pre-authorized payments and ascertain whether the customer in such cases is exhibiting fraudulent behavior or not. Pre-authorized payments include, but are not limited to direct debit, standing instructions and continuous payment authority. The pre-authorized payments are setup as an agreement between the lender and the borrower to allow a lender to withdraw money from the customer's bank account, directly or by using his/her debit or credit card, following a designated and agreed upon (between the lender and borrower) repayment schedule. The borrower has a right to cancel this authority anytime he/she wishes to.

In yet another embodiment, the voice prints generated from communication with the customers can be transcribed into text and lending outcomes can be predicted using NLP or text analytics. Text created from the voice prints undergoes pre-processing like removal of the stop words, standardization of inconsistencies in the text, spell correction, lemmatization, etc. The processed data is used to extract important information and features (including, but not limited to, n-gram flags, flags for words combinations, variable cluster based flags). The features extracted are used as input into classification models (including, but not limited to Naive-Bayes Classification, Maxent method, Log linear models, Average perceptron, SVM, hierarchical clustering). Predictive modeling techniques are used for variable selection, credit risk prediction and fraud detection.

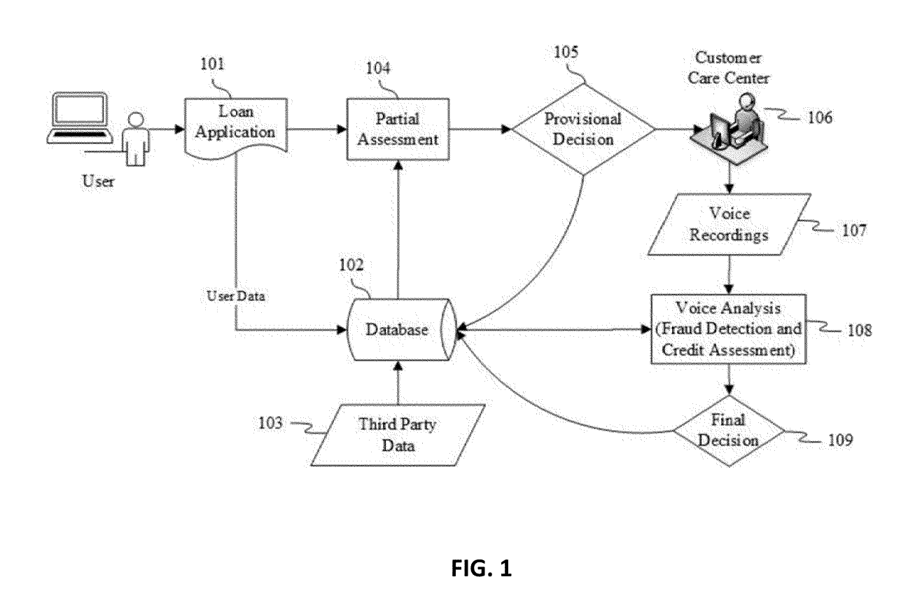

Reference is now made to FIGS. 1-6, which illustrate the processes, methods and components for the present system. It should be understood that these figures are exemplary in nature and in no way serve to limit the scope of the system, which is defined by the claims appearing herein below. The underlying method used in this system is described within.

FIG. 1 illustrates the processes and components of the present system as used for credit risk assessment and fraud detection. Customer comes to a lender's website and fills in his/her details in a loan application 101. Lender saves customer details in a database 102 and fetches third party information 103 to assess whether to lend to this customer or not by running the data assembled through a prediction module 104. The lender provides the customer with a provisional decision 105, as to whether or not customer should move further on his/her application process. This provisional decision is saved in the database 102. If the customer is provisionally approved, he/she is asked to call or receives a call from a customer care centre 106 associated to the lender. The conversation that occurs at the customer care centre is recorded and these voice recordings 107 are passed through a voice analysis module 108. This module can be setup to run in real time (as the conversation occurs) or can be initiated on demand with recorded conversations as input. The agents can also tag/mark sections of the conversation (in real time or after the event), to capture additional data (eg: indicate specific questions being asked to the customer). The voice analysis module 108 picks up various primary and derived features from customer's voice. These features are then input into a system that uses predictive modeling techniques to predict various lending outcomes. The output from this module 108 may be used to determine a probability of a customer defaulting on his/her credit repayment and his intent to pay back his/her loan. This module 108 also may identify the emotions of the customer from voice clips and using the models built and estimate the likelihood of fraud. This system allows assessment of loan applications of borrowers with limited credit history by making use of the reference information. This data constitutes of real time or recorded conversations between an applicant's referrers and representative agents, in addition to credit history and identity information on the reference. This system also evaluates the credit worthiness of a group of consumers as one entity. Additional outcomes can also be estimated including but not limited to: the chance of a customer requesting for a temporary arrangement or entering a debt management plan or an individual voluntary agreement or requesting for cancellation of pre-authorized payments. This module also caters to the voice printing dependant identity and fraud detection. Using this voice printing technology, VIP lists and fraud blacklists are generated which provide a better user experience. A final decision 109 on loan application is output by this module and saved in the database.

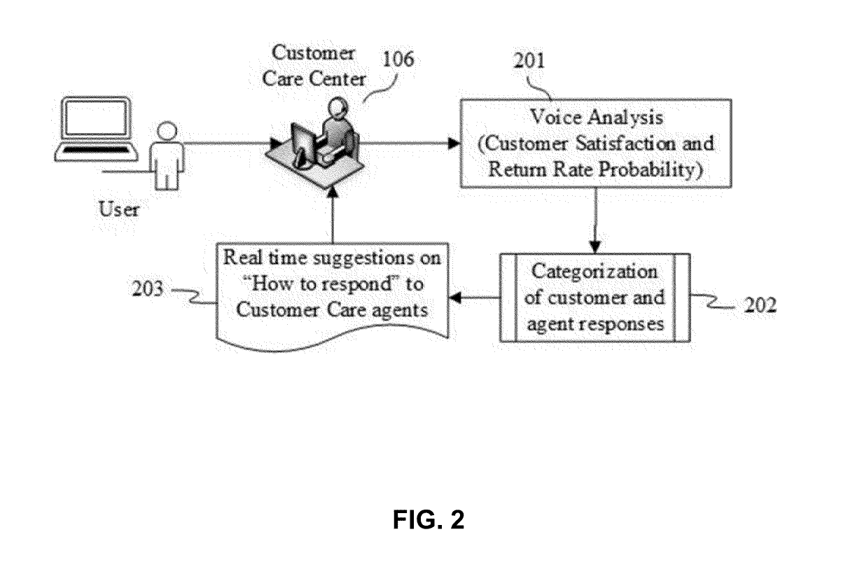

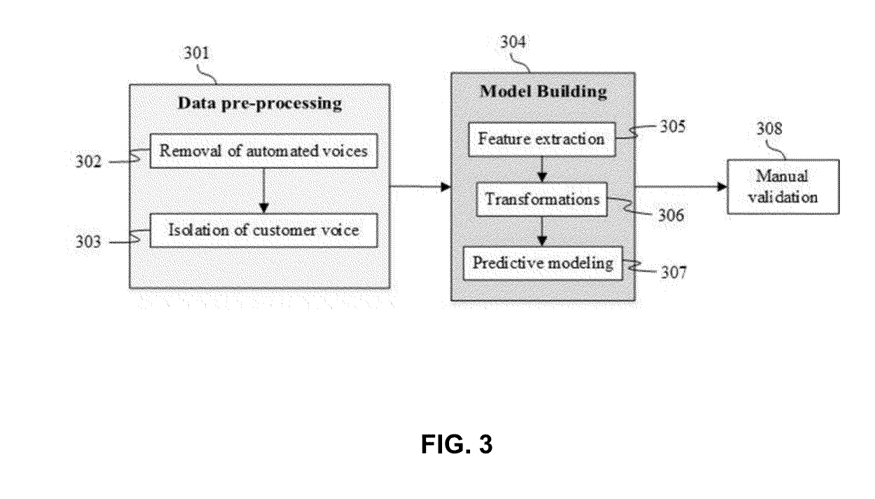

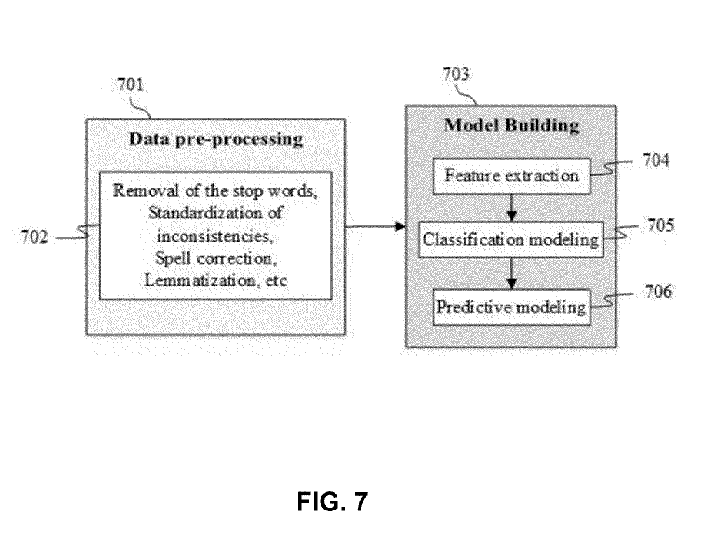

Each component of the system shown in FIGS. 1-3 may be implemented in hardware, software or a combination of hardware and software. Similarly, the system in FIG. 7, including the voice to text conversion and text analysis module also may be implemented in hardware, software or a combination of hardware and software as described below. In a hardware implementation of the system, each component, such as elements 102, 104 and 108 in FIG. 1, element 201, 202 in FIG. 2 and elements 301, 302, 305, 306 and 307 in FIG. 3, shown in FIGS. 1-3 may be implemented in a hardware device, such as a field programmable device, a programmable hardware device or a processor. In a software implementation of the system, each component shown in FIGS. 1-3 may be implemented as a plurality lines of computer code that may be stored on a computer readable medium, such as a CD, DVD, flash memory, persistent storage device, cloud computing storage and then may be executed by a processor. In a combination of hardware and software implementation of the system, each component shown in FIGS. 1-3 may be implemented as a plurality lines of computer code stored in a memory and executed by a processor of a computer system that hosts the system wherein the computer system may be a standalone computer, a server computer, a personal computer, a tablet computer, a smartphone device, a cloud computing resources computer system and the like.

FIG. 2 illustrates the processes and components of the present system as used for measuring customer satisfaction and return rate probability. The user, during the loan application process or otherwise, calls or receives a call from the customer care centre 106. The communication that occurs is recorded and made to pass through the voice analysis module 201, either in real time or on demand. This module detects various emotions in the voice of the customer, categorizes customer and agent responses 202, and in real time recommends as to what should the customer care agents respond 203 in order to ensure maximum customer satisfaction and return rate probability. For example, using the system in FIG. 1, a customer applies for a loan. A risk model M1 is applied at this stage to generate a provisional approval and the loan is sent to call centre for further assessment. The call centre associated with the lender calls up the customer for additional details. During this call the conversation is recorded. From the recordings voice features are extracted as described before, processed and transformed and ultimately used as input (along with the features that were used as input for the model M1) for the predictive model M2 which predicts a more refined probability of credit risk. In this example if M2 predicts a very small probability of default, the customer gets approved for credit. This decision is recorded.

Example for FIG. 2: A customer who has an existing loan, calls the customer service agent representing the lender. This conversation is recorded and voice features are extracted continuously in real time. Based on the conversation and voice features, the system categorizes the emotional state of the customer. Based on the categorization, the system prompts the agent in real time, during the conversation, on how to respond so as ensure the customer is satisfied and continues the relationship with the lender.

FIG. 3 illustrates the major functions and operations of the system for voice analysis for fraud detection and credit assessment. The voice data collected from the call centre recordings mainly has three voice groups, that of customer, call centre agent and the automated IVR. For the intended analysis as defined by the present system, the customer's voice is isolated from the conversation and may be done as a part of data pre-processing 301. The data pre-processing 301 may involve two steps, where any automated voice present in the recording is removed 302 and as the next step, the call centre agents' voices are identified and removed from the voice files 303 which thus isolates the customer's voice.

The voice analysis for fraud detection and credit assessment may also involve a model building process 304. As part of the model building 304, the data from the data pre-processing process 301 may be used for extraction of primary features 305 as described above. These primary features may be further subjected to various mathematical and logical transformations 306 and derived features may be generated (including, but not limited to derivatives of formant frequencies, first and second order derivatives of Mel Frequency Cepstral Coefficients, maximum and minimum deviation from mean value, mean deviation between the adjacent samples, frequency distribution on aggregated deviations, as well as comparative functions of the previously mentioned features computed on segmented conversations using one or more types of segmentations, and digital filter variations of all the previously mentioned features). All of the data created (the primary and derived features from the customer's voice) may be fed into a predictive modeling engine 307 (that may use various predictive modeling techniques including, but not limited to, Regression, Neural networks, SVM, CART, Residual modeling, Bayesian forest, Random forest, Deep learning, Ensemble modeling, and Boosting trees). Manual validations 308 of the outcomes are performed as a final step.

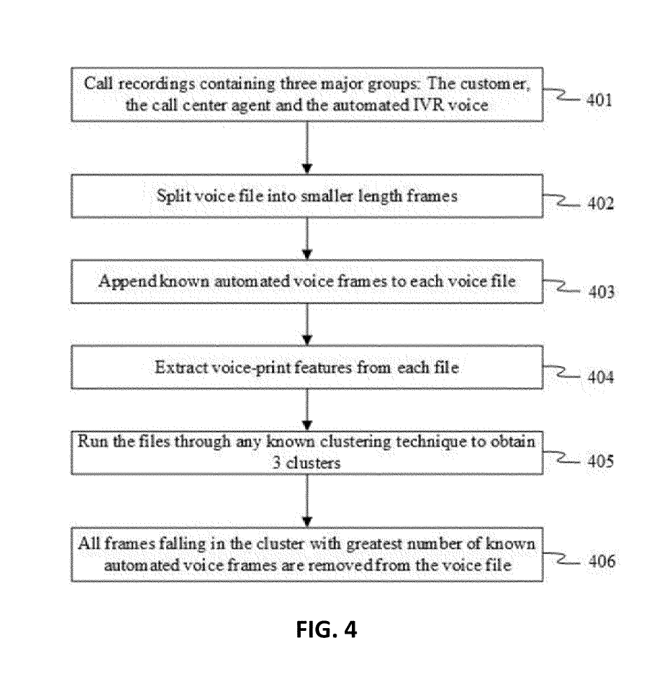

FIG. 4 illustrates the process of the data pre-processing where the automated frames are removed from the voice files. Call recordings are assumed to constitute of three major voice groups, the customers, call centre agents and automated IVR voice 401. The process may split or segment the voice files into smaller frames 402. The splitting can be achieved by tagging conversation based on time, keywords or by identifying pauses in dialogue, to name a few methods. Multiple segmentations can be applied on any given dataset for generating features. Different types of segmentations can be combined to create second order (and higher order) segmentations. The process may then append known automated IVR voice frames to each voice file 403 and extract voice-print features from each frame 404. The process may then run the files through Gaussian mixture model or any other known clustering and classification techniques to obtain three clusters 405 and identify the cluster with maximum number of known automated voice frames. The process may then remove all frames which fell into this cluster from the voice file 406. The final result is voice files that have the customers' voices and call centre agents' voices.

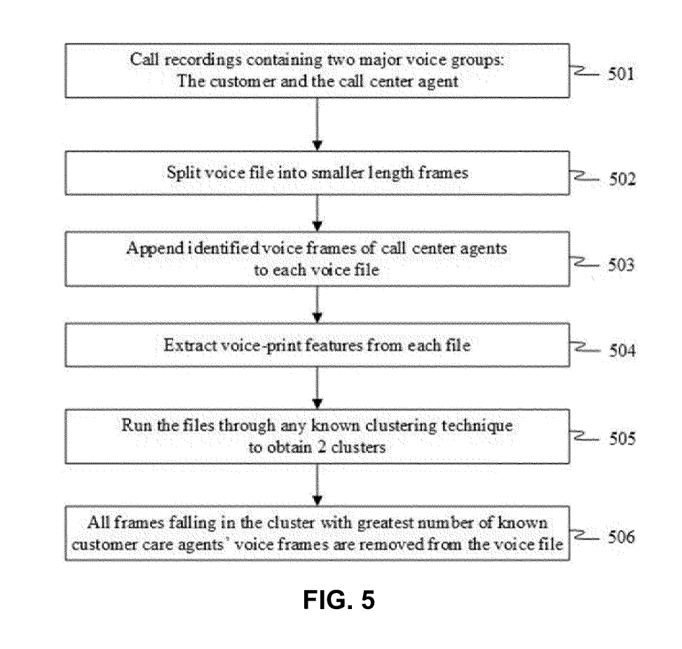

FIG. 5 illustrates the process of the data pre-processing where the customers' voices are isolated from the conversation data, and organized into two major voice groups: the customers' voices and customer care agents' voices 501. The process may split the voice file into smaller length frames 502 and the splitting can be achieved by tagging conversation based on time, keywords or by identifying pauses in dialogue, to name a few methods. Multiple segmentations can be applied on any given dataset for generating features. Different types of segmentations can be combined to create second order (and higher order) segmentations. The process may append identified voice frames of call centre agents to each voice file 503 and may extract voice-print features from each group 504. The process may apply Gaussian mixture model or any other clustering and classification method to obtain two clusters 505 and recognize the cluster that contains maximum number of known customer agents' voice frames. The process may then remove all the voice frames that fall in this cluster from the voice files 506. The final result is a set of records that contain only the customers' voices.

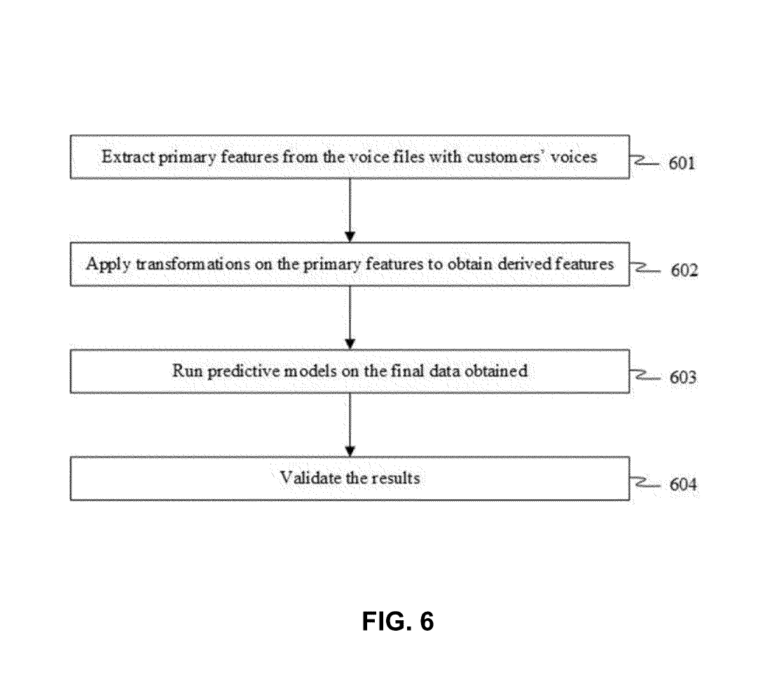

FIG. 6 illustrates the process of the model building part of present system. The process may extract primary features from the voice files that now contain only the customers' voices 601. The primary features are classified based on the domain they are extracted from with time domain primary features capturing the variation of amplitude with respect to time (for example, Amplitude, Sound power, Sound intensity, Zero crossing rate, Mean crossing rate, Pause length ratio, Number of pauses, Number of spikes, Spike length ratio) and the frequency domain primary features capture the variation of amplitude and phase with respect to frequency (for example, MFCCs). The process may apply state-of-the-art transformations on these primary features to obtain derived features 602 that include first and second order derivatives of MFCCs, maximum and minimum deviation from the mean values, mean deviation between adjacent samples, frequency distribution of aggregated deviations. Additionally, digital filters computed on each of these entities, across current and all past conversations involving the customers and/or the agents (involved in the current conversation). The derived features are created using primary features in order to extract more information from voice data. These include features obtained from applying comparative functions on the derived features computed on segments of the conversation (obtained by applying various types of segmentations (including first, second and higher order) across the conversation data.

Before creating predictive models, the data, a sample of data (called the validation sample) is removed from the data to be used for model development (as standard procedure before building models). The purpose of the sample is to ensure that the predictive model is accurate, stable, and works on data not specifically used for training it. Generate predictive models (including, but not limited to, Regression, Neural networks, SVM, CART, Residual modeling, Bayesian forest, Random forest, Deep learning, Ensemble modeling, and Boosting trees) from the final input data 603. The results are validated 604 on the validation sample and the predictive models (that pass validation) are produced as output.

FIG. 7 illustrates the processes and components of voice to text conversion and text analysis module. The voice prints generated from communication with the customers may be transcribed into text. The text created may undergo data pre-processing 701, such as removal of the stop words, standardization of inconsistencies in the text, spell correction, lemmatization, etc 702. As the first step of model building 703, the cleaned up data is used to extract important information and features 704 (including, but not limited to, n-gram flags, flags for words combinations, variable cluster based flags). The features extracted are used as input into classification models 705 (including, but not limited to Naive-Bayes Classification, Maxent method, Log linear models, Average perceptron, SVM, hierarchical clustering). Predictive modeling techniques 706 are used for variable selection, credit risk prediction and fraud detection.

While certain embodiments have been described above, it will be understood that the embodiments described are by way of example only. Accordingly, the systems and methods described herein should not be limited based on the described embodiments. Rather, the systems and methods described should only be limited in light of the claims that follow when taken in conjunction with the above description and accompanying drawings.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A voice analytic based predictive modeling system, comprising:
a processor and a memory;
the processor configured to receive information from an entity and third party information about the entity;
the processor configured to receive voice recordings from a telephone call with the entity;
a voice analyzer component, executed by the processor, that processes the voice recordings of the entity to identify a plurality of features of the entity voice from the voice recordings and generate a plurality of voice feature pieces of data; and
a predictor component, executed by the processor, that generates an outcome of an event for the entity based on the voice features piece of data, the information from the entity and third party information about the entity.

2. The system of claim 1, wherein the predictor component generates a provisional approval for a loan to the entity based on the loan application from the entity and third party information about the entity.

3. The system of claim 1, wherein the voice analyzer component separates the voice recordings of the entity into one or more voice recording segments.

4. The system of claim 3, wherein the voice analyzer component separates the voice recordings of the entity using a plurality of segmentation processes.

5. The system of claim 4, wherein the plurality of segmentation processes further comprise the voice analyzer component generating a segment of a question from an agent and an answer from the entity.

6. The system of claim 4, wherein the plurality of segmentation processes further comprise the voice analyzer component generating a segment of a specific dialog in the voice recordings.

7. The system of claim 4, wherein the plurality of segmentation processes further comprise the voice analyzer component generating a segment of a phrase in the voice recording.

8. The system of claim 4, wherein the plurality of segmentation processes further comprise the voice analyzer component generating a segment based on a frequently used word in the voice recording.

9. The system of claim 4, wherein the plurality of segmentation processes further comprise the voice analyzer component generating a segment based on a tag created by an agent during a conversation with the entity.

10. The system of claim 4, wherein the plurality of segmentation processes further comprise the voice analyzer component generating a segment based on a tag created by an agent during a conversation with the entity.

11. The system of claim 4, wherein the plurality of segmentation processes further comprise the voice analyzer component generating a segment based on a keyword trigger.

12. The system of claim 1, wherein the feature is a reference in the voice recording.

13. The system of claim 1, wherein the voice analyzer component is configured to determine a human emotion based on voice recordings.

14. The system of claim 1, wherein the voice analyzer component is configured to create one of a VIP list and a fraud blacklist

15. The system of claim 1, wherein the voice analyzer component is configured to transcribe the voice recording into text and analyzes the text.

16. The system of claim 1, wherein the plurality of features further comprises a primary feature and a derived feature.

17. The system of claim 16, wherein the voice analyzer component is configured to generate the derived feature by applying a transformation to the primary feature.

18. The system of claim 16, wherein the primary feature is one of a time domain primary feature that captures variations of amplitude of the voice recording in a time domain and a frequency domain primary feature that captures variations of amplitude and phase of the voice recording in a frequency domain.

19. The system of claim 16, wherein the derived feature is one of a derivative of formant frequencies, a first and second order derivative of a Mel Frequency Cepstral Coefficient, a maximum and minimum deviation from mean value, a mean deviation between adjacent samples, a frequency distribution on aggregated deviations and a digital filter.

20. The system of claim 1, wherein the entity is one of an individual and a group of individuals.

21. The system of claim 1, wherein the event is a return of the entity to a business and the voice analyzer component categorizes the voice recordings in real time and generates a recommendations for use in a customer care centre.

22. The system of claim 1, wherein the event is a loan to the entity and the information from the entity is a loan application.

23. The system of claim 1, wherein the event is a return of the entity to a business and the information from the entity is a call with customer service.

24. A method for predictive modeling using voice analytics, the method comprising:
receiving information from an entity and third party information about the entity;
receiving voice recordings from a telephone call with the entity;
processing, a voice analyzer component, the voice recordings of the entity to identify a plurality of features of the entity voice from the voice recordings and generate a plurality of voice feature pieces of data; and
generating, by a predictor component, an outcome of an event for the entity based on the voice features piece of data, the information from the entity and third party information about the entity.

25. The method of claim 24 further comprising generating a provisional approval for a loan to the entity based on the loan application from the entity and third party information about the entity.

26. The method of claim 24, wherein processing the voice recordings further comprises separating the voice recordings of the entity into one or more voice recording segments.

27. The method of claim 26, wherein separating the voice recordings further comprises separating the voice recordings of the entity using a plurality of segmentation processes.

28. The method of claim 26 further comprising generating a segment of a question from an agent and an answer from the entity.

29. The method of claim 26 further comprising generating a segment of a specific dialog in the voice recordings.

30. The method of claim 26 further comprising generating a segment of a phrase in the voice recording.

31. The method of claim 26 further comprising generating a segment based on a frequently used word in the voice recording.

32. The method of claim 26 further comprising generating a segment based on a tag created by an agent during a conversation with the entity.

33. The method of claim 26 further comprising generating a segment based on a tag created by an agent during a conversation with the entity.

34. The method of claim 26 further comprising generating a segment based on a keyword trigger.

35. The method of claim 24, wherein the feature is a reference in the voice recording.

36. The method of claim 24 further comprising determining a human emotion based on voice recordings.

37. The method of claim 24 further comprising creating one of a VIP list and a fraud blacklist based on the features.

38. The method of claim 24, wherein processing the voice recordings further comprises transcribing the voice recording into text and analyzing the text.

39. The method of claim 24, wherein the plurality of features further comprises a primary feature and a derived feature.

40. The method of claim 39 further comprising generating the derived feature by applying a transformation to the primary feature.

41. The method of claim 39, wherein the primary feature is one of a time domain primary feature that captures variations of amplitude of the voice recording in a time domain and a frequency domain primary feature that captures variations of amplitude and phase of the voice recording in a frequency domain.

42. The method of claim 39, wherein the derived feature is one of a derivative of formant frequencies, a first and second order derivative of a Mel Frequency Cepstral Coefficient, a maximum and minimum deviation from mean value, a mean deviation between adjacent samples, a frequency distribution on aggregated deviations and a digital filter.

43. The method of claim 24, wherein the entity is one of an individual and a group of individuals.

44. The method of claim 24, wherein the event is a return of the entity to a business and further comprising categorizing the voice recordings in real time and generating a recommendations for use in a customer care centre.

45. The method of claim 24, wherein the event is a loan to the entity and the information from the entity is a loan application.

46. The method of claim 24, wherein the event is a return of the entity to a business and the information from the entity is a call with customer service.
